(19) United States
(12) Patent Application Publication
(10) Pub. No.: US 2013/0255057 A1
(43) Pub. Date: Oct. 3, 2013

(54) MOUNTING HEAD UNIT, COMPONENT MOUNTING APPARATUS, METHOD OF MANUFACTURING A SUBSTRATE, AND ROTATION DRIVING MECHANISM

(71) Applicant: SONY CORPORATION, Tokyo (JP)

(72) Inventors: Yousuke Komatsu, Saitama (JP); Tadahiro Satoh, Kanagawa (JP)

(73) Assignee: Sony Corporation, Tokyo (JP)

(21) Appl. No.: 13/847,526

(22) Filed: Mar. 20, 2013

(30) Foreign Application Priority Data
Mar. 27, 2012 (JP) 2012-070862

(51) Int. Cl. B23Q 3/00; B23Q 5/02

(52) U.S. Cl. CPC B23Q 3/00; B23Q 5/02
USPC 29/428; 269/57; 74/412 R

(57) ABSTRACT

A mounting head unit includes a main body section, a plurality of retaining sections, and a driving mechanism. The plurality of retaining sections are configured to be capable of retaining a plurality of components. The plurality of retaining sections each have a longitudinal direction and are rotatably supported by the main body section to be arranged in a direction across the longitudinal directions. The driving mechanism include a plurality of rotation mechanism sections respectively mounted on the plurality of retaining sections for rotating each of the plurality of retaining sections such that the rotation mechanism sections are mounted at different mounting positions in the longitudinal directions of the retaining sections adjacent to each other.

### BACKGROUND

The present disclosure relates to a mounting head unit for mounting electronic components on a substrate, to a component mounting apparatus, to a method of manufacturing a substrate, and to a rotation driving mechanism.

In the related art, a component mounting machine using a rotatable rotary head as described in Japanese Patent No. 3750170 (hereinafter, referred to as Patent Document 1) is known. In a circumference of the rotating rotary head, a number of suction nozzles movable upwards and downwards are arranged. As shown in FIG. 1 of Patent Document 1, a support section of the rotary head is rotated by a rotation of a base shaft. The suction nozzles provided to the support section rotationally move. A predetermined suction nozzle is located at a suction position. The suction nozzle located at the suction position sucks an electronic component.

Further, a rotating tube rotatable coaxially with the base shaft is provided with a rotating disk at a lower end portion (position close to support section). The rotating disk is provided such that an outer peripheral surface of the rotating disk is held in contact with frictional rings provided to the suction nozzles. When the rotating disk rotates, rotational force is applied to the suction nozzles through the frictional rings. With this, the suction nozzles rotate. Thus, orientations of components sucked by the suction nozzles are corrected.

### SUMMARY

In order to enhance productivity of a substrate on which electronic components are mounted, it is assumed to increase the number of suction nozzles. However, it is desirable to reduce the size and weight of the rotary head. As the number of suction nozzles is increased, it becomes difficult to reduce the size of the rotary head.

In view of the above-mentioned circumstances, it is desirable to provide a mounting head unit, a component mounting apparatus, a method of manufacturing a substrate, and a rotation driving mechanism that enable downsizing to be achieved while increasing the number of retaining sections for retaining a component and the like.

According to an embodiment of the present disclosure, there is provided a mounting head unit including a main body section, a plurality of retaining sections, and a driving mechanism.

The plurality of retaining sections are configured to retain a plurality of components, the plurality of retaining sections each having a longitudinal direction and rotatably supported by the main body section to be arranged in a direction across the longitudinal directions.

The driving mechanism includes rotation mechanism sections respectively mounted on the plurality of retaining sections for rotating each of the plurality of retaining sections such that the rotation mechanism sections are mounted at different mounting positions in the longitudinal directions of the retaining sections adjacent to each other.

In this mounting head unit, the rotation mechanism sections are respectively mounted on the retaining sections for rotating each of the plurality of retaining sections. The rotation mechanism sections are provided such that the rotation mechanism sections are mounted at different mounting positions in the longitudinal directions of the retaining sections adjacent to each other. Therefore, the plurality of retaining sections can be provided to the main body section such that the retaining sections adjacent to each other are sufficiently close to each other in the direction across the longitudinal directions. As a result, the number of retaining sections can be increased without increasing the size of the main body section. That is, downsizing of the mounting head unit can be achieved while increasing the number of retaining sections for retaining a component and the like.

The driving mechanism may include a rotation driving section configured to rotate each of the plurality of rotation mechanism sections mounted on the plurality of retaining sections.

In this mounting head unit, the rotation mechanism section is rotated, to thereby rotate the retaining sections. Further, the rotation driving section configured to rotate each of the plurality of rotation mechanism sections is provided. With this, downsizing of the mounting head unit can be achieved.

The plurality of rotation mechanism sections may include a plurality of gears. In this case, the rotation driving section may include a driving gear to be engaged to each of the plurality of gears.

The driving gear configured to rotate each of the plurality of gears may be provided. With this, downsizing of the mounting head unit can be achieved.

The main body section may include a rotating body having an axis of rotation. In this case, the plurality of retaining sections may be supported by an outer peripheral portion of the rotating body. Further, the driving gear may be provided in an area surrounded by the plurality of retaining sections to be rotatable coaxially with the axis of rotation.

By providing the driving gear to be rotatable coaxially with the rotating body, downsizing of the mounting head unit can be achieved.

The plurality of retaining sections may be supported such that the longitudinal directions are oblique to the axis of rotation. Further, the mounting head unit may further include a support body configured to support the axis of rotation obliquely to a vertical direction such that the longitudinal direction of at least one of the plurality of retaining sections is along the vertical direction.

The axis of rotation is supported obliquely to the vertical direction, and hence the at least one retaining section described above is provided in the vertical direction and the other retaining sections are provided at higher positions with respect to the vertical direction. It becomes possible to easily perform a check and the like of a retaining state of a component on the retaining sections provided at the higher positions.

The plurality of retaining sections may be supported obliquely to the rotating body such that one end portions of the plurality of retaining sections are closer to the axis of rotation than the other end portions of the plurality of retaining sections, the other end portions being configured to retain the plurality of components. In this case, the plurality of gears may be configured to individually rotate with the longitudinal directions of the retaining sections, on which the plurality of gears are mounted, being axes. Further, the driving gear may include a tapered engagement surface provided in directions along the longitudinal directions to be oblique to the axis of rotation for being engaged to each of the plurality of gears.

The plurality of gears may be mounted alternately at a first mounting position and a second mounting position different from the first mounting position in the longitudinal directions of the plurality of retaining sections.

The plurality of gears may be provided alternately at the first mounting position and the second mounting position. With this, it becomes easy to mount the plurality of gears on the plurality of retaining sections. Further, the configuration of the driving mechanism can be prevented from being complicated.

The driving gear may include teeth formed in the tapered engagement surface with a middle point between an first engagement area configured to be engaged to the gear mounted at the first mounting position and a second engagement area configured to be engaged to the gear mounted at the second mounting position being a reference of a tooth width.

In this mounting head unit, the teeth are formed in the tapered engagement surface with the middle point between the first engagement area and the second engagement area being a reference of the tooth width. With this, an engagement state between the driving gear and the plurality of gears mounted alternately at the first mounting position and the second mounting position can be made good.

The plurality of retaining sections may include a plurality of nozzles configured to be capable of sucking the plurality of components.

The rotation mechanism sections may include motors.

According to another embodiment of the present disclosure, there is provided a component mounting apparatus including a support unit, a main body section, a plurality of retaining sections, and a driving mechanism.

The support unit is configured to support a substrate.

The main body section is configured to be movable above the substrate supported by the support unit.

The plurality of retaining sections are configured to retain a plurality of components and mount the plurality of retained components on the substrate, the plurality of retaining sections each having a longitudinal direction and rotatably supported by the main body section to be arranged in a direction across the longitudinal directions.

The driving mechanism includes a plurality of rotation mechanism sections respectively mounted to the plurality of retaining sections for rotating each of the plurality of retaining sections such that the rotation mechanism sections are mounted at different mounting positions in the longitudinal directions of the retaining sections adjacent to each other.

According to still another embodiment of the present disclosure, there is provided a method of manufacturing a substrate by a component mounting apparatus including a support unit configured to support the substrate and a mounting head unit configured to mount a component on the substrate.

The mounting head unit includes a main body section, a plurality of retaining sections, and a driving mechanism.

The main body section is configured to be movable above the substrate supported by the support unit.

The plurality of retaining sections are configured to retain a plurality of components, the plurality of retaining sections each having a longitudinal direction and rotatably supported by the main body section to be arranged in a direction across the longitudinal directions.

The driving mechanism includes a plurality of rotation mechanism sections mounted to the plurality of retaining sections for rotating each of the plurality of retaining sections such that the rotation mechanism sections are mounted at different mounting positions in the longitudinal directions of the retaining sections adjacent to each other.

This method of manufacturing a substrate includes retaining the plurality of components by the plurality of retaining sections.

By rotating each of the plurality of retaining sections by the plurality of rotation mechanism sections respectively mounted on the plurality of retaining sections of the driving mechanism, an orientation of each of the plurality of components retained by the plurality of retaining sections is adjusted.

The main body section is moved above the substrate and the plurality of components are mounted on the substrate by the plurality of retaining sections.

According to still another embodiment of the present disclosure, there is provided a rotation driving mechanism including a main body section, a plurality of members, and a driving mechanism.

The plurality of members each have a longitudinal direction and are rotatably supported by the main body section to be arranged in a direction across the longitudinal directions.

The driving mechanism includes rotation mechanism sections respectively mounted on the plurality of members for rotating each of the plurality of members such that the rotation mechanism sections are mounted at different mounting positions in the longitudinal directions of the members adjacent to each other, and a rotation driving section used for rotating each of the plurality of rotation mechanism sections mounted on the plurality of members, the rotation driving section being common to the plurality of members.

As described above, according to the embodiments of the present disclosure, downsizing can be achieved while increasing the number of retaining sections for retaining a component and the like.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a schematic front view showing a component mounting apparatus according to an embodiment of the present disclosure;

FIG. 2 is a plan view of the component mounting apparatus shown in FIG. 1;

FIG. 3 is a side view of the component mounting apparatus shown in FIG. 1;

FIG. 4 is a cross-sectional view showing a configuration of a mounting head unit according to this embodiment;

FIG. 5 is a perspective view mainly showing a turret and a plurality of nozzle units;

FIG. 6 is a cross-sectional view mainly showing a driving mechanism and the plurality of nozzle units;

FIG. 7 is a schematic perspective view for explaining a position relationship between a driving gear and first and second gears;

FIG. 8 is a schematic plan view showing the driving gear and the first and second gears;

FIG. 9 is a cross-sectional view schematically showing engagement between the driving gear and the first gear;

FIG. 10 is a cross-sectional view schematically showing engagement between the driving gear and the second gear;

FIGS. 11A and 11B are schematic views for explaining teeth formed in a tapered engagement surface of the driving gear;

FIG. 12 is a schematic view for explaining teeth formed in a tapered engagement surface of the driving gear;

FIG. 13 is a perspective view schematically showing the driving gear manufactured according to another embodiment;

FIG. 14 is a view for explaining a method of manufacturing the driving gear shown in FIG. 13;

FIG. 15 is a view for explaining suction operations of electronic components by the mounting head unit; and

FIG. 16 is a view for explaining mounting operations of the electronic components by the mounting head unit.

### DETAILED DESCRIPTION OF EMBODIMENTS

Hereinafter, an embodiment of the present disclosure will be described with reference to the drawings.

### Operation of Component Mounting Apparatus

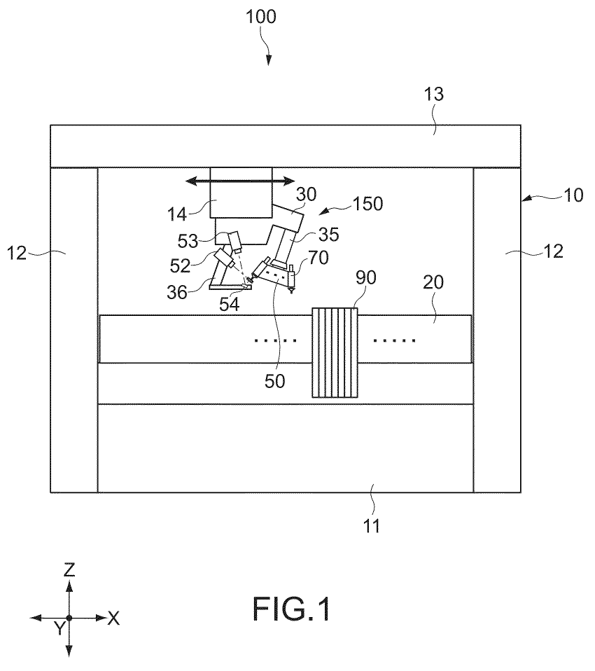

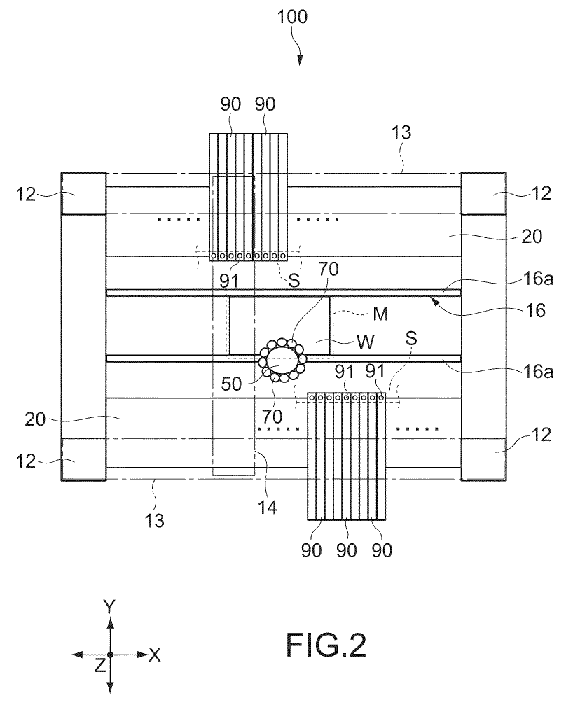

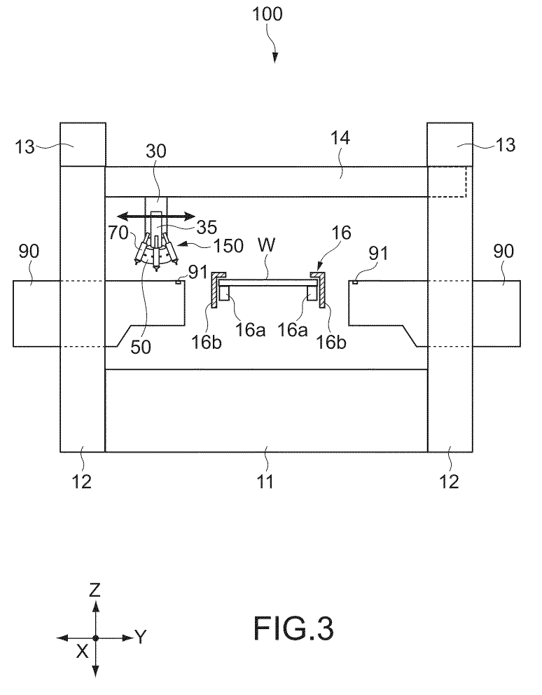

FIG. 1 is a schematic front view showing a component mounting apparatus 100 according to an embodiment of the present disclosure. FIG. 2 is a plan view of the component mounting apparatus 100 shown in FIG. 1. FIG. 3 is a side view of the component mounting apparatus 100.

The component mounting apparatus 100 includes a frame 10, a mounting head unit 150, and tape feeder installation portions 20. The mounting head unit 150 retains an electronic component (not shown) and mounts the electronic component on a circuit substrate W (hereinafter, abbreviated as substrate) being a mounting target. In the tape feeder installation portions 20, tape feeders 90 are installed. Further, the component mounting apparatus 100 includes a conveyor unit 16 (see FIG. 2) that retains and conveys the substrate W.

The frame 10 includes a base 11 provided at a bottom and a plurality of support columns 12 fixed to the base 11. Upper portions of the plurality of support columns 12 are provided with, for example, two X-beams 13 along an X-axis in the figure.

For example, between the two X-beams 13, a Y-beam 14 is provided along a Y-axis. To the Y-beam 14, the mounting head unit 150 is connected. The X-beams 13 and the Y-beam 14 are equipped with an X-axis movement mechanism and a Y-axis movement mechanism (not shown), respectively. Those movement mechanisms allow the mounting head unit 150 to move along the X-axis and the Y-axis. Although the X-axis movement mechanism and the Y-axis movement mechanism are typically constituted of ball-screw driving mechanisms, other mechanisms such as a belt driving mechanism may be employed.

A plurality of mounting head units 150 may be provided mainly in order to enhance productivity. In this case, the plurality of mounting head units 150 are independently driven in an X-axis direction and a Y-axis direction.

As shown in FIG. 2, the tape feeder installation portions 20 are provided on both of a front side (lower side in FIG. 2) and a rear side (upper side in FIG. 2) of the component mounting apparatus 100. The Y-axis direction in the drawings is front and rear directions of the component mounting apparatus 100.

In each of the tape feeder installation portion 20, the plurality of tape feeders 90 are arranged and installed along the X-axis direction. For example, 40 to 70 tape feeders 90 may be installed in the tape feeder installation portion 20. In this embodiment, 116 tape feeders 90 in total (58 on the front side and 58 on the rear side) may be installed.

Note that, although the tape feeder installation portions 20 are provided on both of the front side and the rear side of the component mounting apparatus 100, the tape feeder installation portions 20 may be provided on either one of the front side and the rear side.

The tape feeder 90 is formed to be long in the Y-axis direction. Although not shown in the drawings in detail, the tape feeder 90 includes a reel, and a carrier tape housing electronic components such as a capacitor, a resistor, a light-emitting diode (LED), and an integrated circuit (IC) packaging is wound around the reel. Further, the tape feeder 90 includes a mechanism for feeding the carrier tape in a stepwise manner. For each stepwise feeding, the electronic components are fed one by one.

As shown in FIG. 2, a supply window 91 is formed in an upper surface of an end portion of a cassette of the tape feeder 90. Through the supply window 91, the electronic components are supplied. An area in which the plurality of supply windows 91 are arranged, which is formed along the X-axis direction when the plurality of tape feeders 90 are arranged, serves as a supply area S of the electronic components.

Note that, in the carrier tape of one of the tape feeders 90, a large number of the same kind of electronic components are housed. Among the tape feeders 90 to be installed in the tape feeder installation portion 20, the same kind of electronic components may be housed over the plurality of tape feeders 90.

At a center portion of the component mounting apparatus 100 in the Y-axis direction, the conveyor unit 16 is provided. The conveyor unit 16 coveys the substrate W along the X-axis direction. For example, as shown in FIG. 2, an area of the conveyor unit 16 at an almost center position in the X-axis direction, above which the substrate W is supported by the conveyor unit 16, serves as a mounting area M. The mounting area M is an area in which mounting of an electronic component is performed by the mounting head unit 150 accessing the area.

As shown in FIG. 1, the component mounting apparatus 100 includes a first camera 52 and a second camera 53. The first camera 52 images a nozzle unit 70 retaining an electronic component from the side. The second camera 53 images the nozzle unit 70 from below through a mirror 54.

The first camera 52, the second camera 53, and the mirror 54 are supported by a support table 36. The support table 36 is connected to the X-axis movement mechanism and the Y-axis movement mechanism. The support table 36 is movable integrally with the mounting head unit 150. That is, the first camera 52, the second camera 53, and the like are movable integrally with the mounting head unit 150.

The first camera 52 is located at a position such that the first camera 52 can image the highest nozzle unit 70 among a plurality of nozzle units 70 (in FIG. 1, nozzle unit 70 on leftmost side) from the side.

The second camera 53 is located at a position such that the second camera 53 can image the highest nozzle unit 70 among the plurality of nozzle units 70 from below through the mirror 54. Note that, hereinafter, the position of the nozzle unit 70 imaged by the first camera 52 and the second camera 53 is referred to as an imaging position.

Imaging by the first camera 52 and the second camera 53 is performed at the imaging position. Based on the captured image, a suction state of an electronic component is recognized. For example, it is recognized whether or not the electronic components are normally sucked by the nozzle units 70. Further, orientations and the like of the electronic components sucked by the nozzle unit 70 are recognized. For example, based on the recognition result, the nozzle unit 70 is appropriately rotated to correct the orientations of the sucked electronic components. Alternatively, it may be recognized whether or not the sucked electronic components have deficiencies, for example.

The first camera 52 and the second camera 53 are constituted of, for example, a charge coupled device (CCD) or a complementary metal oxide semiconductor (CMOS).

Further, the component mounting apparatus 100 includes a substrate camera (not shown) for detecting an accurate position of the substrate W conveyed to the mounting area M. After the accurate position of the substrate W is detected, the mounting head unit 150 starts a mounting operation of the electronic component. The substrate camera is connected to the X-axis movement mechanism and the Y-axis movement mechanism and movable integrally with the mounting head unit 150.

Although will be also described later, the mounting head unit 150 includes a support 30, a base shaft 35, and a turret 50. The support 30 is connected to the Y-axis movement mechanism of the Y-beam 14. The base shaft 35 serves as a main rotating shaft supported by the support 30. The turret 50 is fixed to a lower end portion of the base shaft 35. Further, the mounting head unit 150 includes a plurality of nozzle units 70 connected to an outer peripheral portion of the turret 50. For example, 16 nozzle units 70 are provided. The number of nozzle units 70 is not limited.

Note that the support 30 may be connected to the X-axis movement mechanism. In this case, the Y-axis movement mechanism moves the X-axis movement mechanism and the mounting head unit 150 along the Y-axis direction.

The mounting head unit 150 is movable in the X-axis direction and the Y-axis direction as described above. The nozzle units 70 move between the supply area S and the mounting area M. Further, the nozzle units 70 move in the X-axis direction and the Y-axis direction within the mounting area M in order to perform mounting in the mounting area M.

While rotating the turret 50, the mounting head unit 150 causes the plurality of nozzle units 70 to respectively retain the plurality of electronic components continuously in a single step. Further, the plurality of electronic components sucked by the plurality of nozzle units 70 are continuously mounted on one substrate W. At this time, each of the plurality of nozzle units 70 is rotated such that the orientation of each of the plurality of electronic components retained by the plurality of nozzle units is appropriately adjusted.

Although the conveyor unit 16 is typically a belt type conveyor, the present disclosure is not limited thereto and any conveyor unit, for example, a roller type, a type in which a supporting mechanism that supports the substrate W moves slidably, or a non-contact type may be employed. The conveyor unit 16 includes belt portions 16a and guide rails 16b laid along the X-axis direction. Due to the provision of the guide rails 16b, the substrate W is conveyed while misalignment of the conveyed substrate W in the Y-axis direction is corrected.

To the belt portions 16a, a lifting and lowering mechanism (not shown) is connected. On the belt portions 16a, the substrate W is placed. In this state, by lifting the belt portions 16a in the mounting area M, the substrate W is retained while being sandwiched between the belt portions 16a and the guide rails 16b. In this case, the belt portions 16a and the guide rails 16b function as a retaining unit for a substrate. That is, the retaining unit forms part of the conveyor unit 16.

### Configuration of Mounting Head Unit

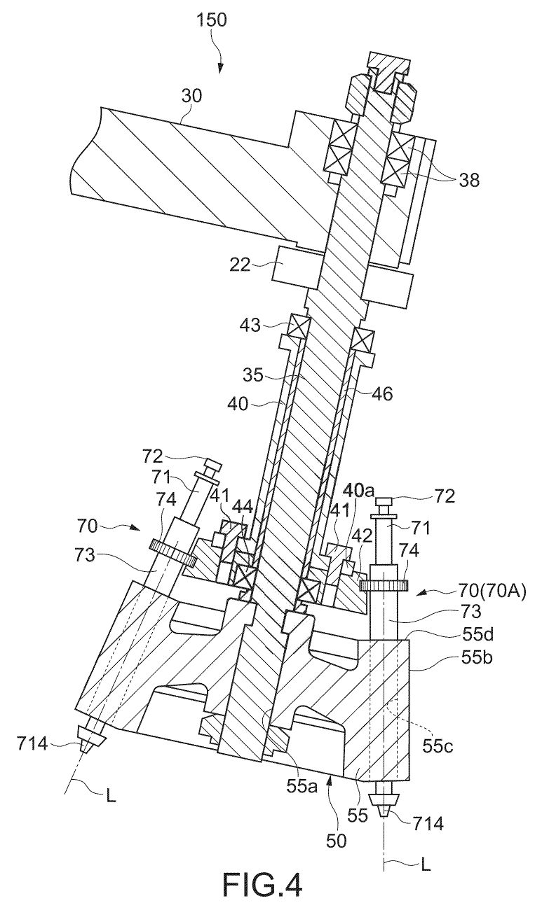

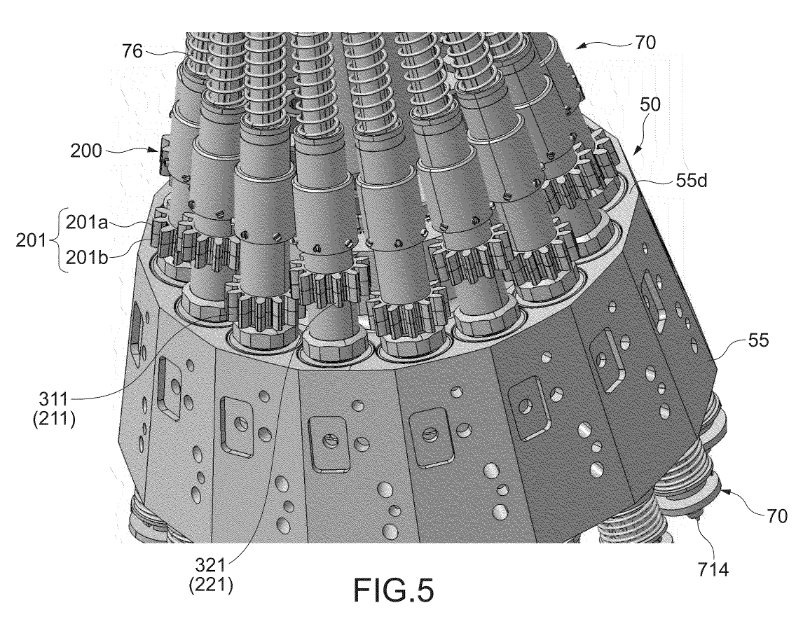

FIG. 4 is a cross-sectional view showing a configuration of the mounting head unit 150 according to this embodiment. FIG. 5 is a perspective view mainly showing the turret 50 and the plurality of nozzle units 70. Note that, in FIG. 4, illustration of a supply channel and the like of the air supplied for sucking the electronic component is omitted.

Referring to FIG. 4, as described above, the mounting head unit 150 includes the support 30, the base shaft 35 supported by the support 30, and the turret 50 provided to the lower end portion of the base shaft 35. In the outer peripheral portion of the turret 50, the plurality of the nozzle units 70 are supported.

In this embodiment, the base shaft 35 and the turret 50 as the axis of rotation correspond to a main body section. Mainly the base shaft 35 and the turret 50 constitute a rotating body including the axis of rotation.

As shown in FIG. 4, the support 30 supports the base shaft 35 orthogonally to a vertical direction (Z-axis direction). The support 30 rotatably supports the upper portion of the base shaft 35 by a bearing 38. On a lower portion side of the support 30, a pulley 37 is fixed to the base shaft 35. Although not shown in the drawings, a motor is connected to the pulley 22 via a belt. With this, the base shaft 35 is rotationally driven.

The turret 50 includes a main body 55 in which a mounting hole 55a is formed. The base shaft 35 is inserted into the mounting hole 55a and fixed therein. With this, the base shaft 35 and the turret 50 are integrally rotatable with the base shaft 35 being a center axis of rotation.

The main body 55 of the turret 50 has a shape such that a diameter decreases toward the position of the support 30 (upwardly) along the direction of the base shaft 35. Therefore, an outer peripheral surface 55b of the main body 55 has a tapered shape. In an outer peripheral portion of the main body 55, a plurality of support holes 55c along the outer peripheral surface 55b are formed. The nozzle units 70 are rotatably provided to the support holes 55c.

In this embodiment, the plurality of nozzle units 70 correspond to a plurality of retaining sections capable of retaining a plurality of electronic components supplied to the supply area S.

Each of the nozzle units 70 includes a nozzle 71 and a nozzle holder 73 covering an outer circumference of the nozzle 71. The nozzle holder 73 is rotatably connected to the turret 50 via a bearing (not shown) at both end portions of the nozzle holder 73.

In the tip end portion 714 of the nozzle 71, a hole (not shown) is formed. The size of the hole in the tip end portion 714 is set to be a size to retain the electronic component smaller than the size of 1 mm*1 mm, for example. A plurality of holes may be provided.

As shown in FIG. 5, a coil spring 76 is provided on the upper portion of the nozzle 71. For example, a pressing roller of a nozzle driving unit (not shown) downwardly pushes the upper end portion 72 of the nozzle 71 against a biasing force of the coil spring 76. When the nozzle 71 moves and descends within the nozzle holder 73, the coil spring 76 is contracted. When the press by the pressing roller is released, the nozzle 71 ascends due to a returning force of the coil spring 76. As the nozzle driving unit, for example, a well-known mechanism as shown in Japanese Patent Application Laid-open No. 2005-150638 may be used.

The plurality of nozzle units 70 each have a longitudinal direction L and are rotatably supported by the turret 50 to be arranged in a direction across the longitudinal directions L. In this embodiment, the direction across the longitudinal directions L corresponds to a plane direction of an upper surface 55d of the main body 55.

Although the upper surface 55d according to this embodiment is tilted toward the base shaft 35, the upper surface 55d is not limited to such a shape. That is, there is no limitation on the arrangement direction in which the plurality of nozzle units 70 are arranged (direction across longitudinal directions L). The arrangement direction may be orthogonal to the longitudinal directions L. The arrangement direction does not need to be orthogonal to the longitudinal directions L.

The plurality of nozzle units 70 are provided at equal intervals in a circumference with the base shaft 35 being a center. The plurality of nozzle units 70 are supported by the outer peripheral portion of the turret 50 such that the longitudinal direction L of each of the nozzle units 70 is oblique to a direction of the base shaft 35. The plurality of nozzle units 70 are provided in an orientation such that the longitudinal directions L of the plurality of nozzle units 70 radially extend with the base shaft 35 being a center.

Specifically, as shown in FIG. 4 and the like, the plurality of nozzle units 70 are supported such that the upper end portion 72 in an opposite side of the tip end portion 714 of each nozzle 71 retaining an electronic component is closer to the base shaft 35. The tip end portion 714 of the nozzle 71 is located at a position away from the base shaft 35. As a result, the tip end portion 714 of the nozzle 71 is located in a circumference of a circle with the base shaft 35 being a center (referred to as first circle). The upper end portion 72 in the opposite side is located in a circumference of a circle with the base shaft 35 being a center, which is a circle having a smaller radius than that of the first circle.

The base shaft 35 is supported by the support 30 such that the longitudinal direction of at least one nozzle unit 70 of the plurality of nozzle units 70 is along the vertical direction (Z-axis direction). Out of the plurality of nozzle units 70, one provided to have the longitudinal direction L along the Z-axis direction is a nozzle unit 70A selected for mounting the electronic component on the substrate W.

By a rotation of the turret 50, any one nozzle unit 70A is selected. The selected nozzle unit 70A accesses the supply window 91 of the tape feeder 90, sucks and retains an electronic component, moves to the mounting area M, and then descends. In this manner, the electronic component is mounted on the substrate W.

Hereinafter, the position of the nozzle unit 70A provided to have the longitudinal direction L along the Z-axis direction is referred to as a nozzle operation position. The nozzle unit 70A located at the nozzle operation position sucks the electronic component and mounts the electronic component on the substrate. In this embodiment, the above-mentioned imaging position is located at a position almost 180 degrees opposite to the nozzle operation position with respect to the turret 50.

In this embodiment, the base shaft 35 is supported obliquely to the vertical direction, and hence the nozzle unit 70 at the imaging position is located at a higher position with respect to the vertical direction. When the nozzle unit 70 is provided at the higher position, it becomes easy for the first camera 52 and the second camera 53 to perform the imaging and a retaining state and the like of the component can be easily checked. Further, the nozzle unit 70 is provided at the highest position, and hence mounting and the like of the first camera 52 and the second camera 53 that image the nozzle unit 70 also become easy. The range of selection for mounting positions of the first camera 52 and the second camera 53 is enlarged, and it becomes possible to achieve downsizing of the component mounting apparatus 100 by appropriately setting the mounting positions.

### Configuration of Driving Mechanism

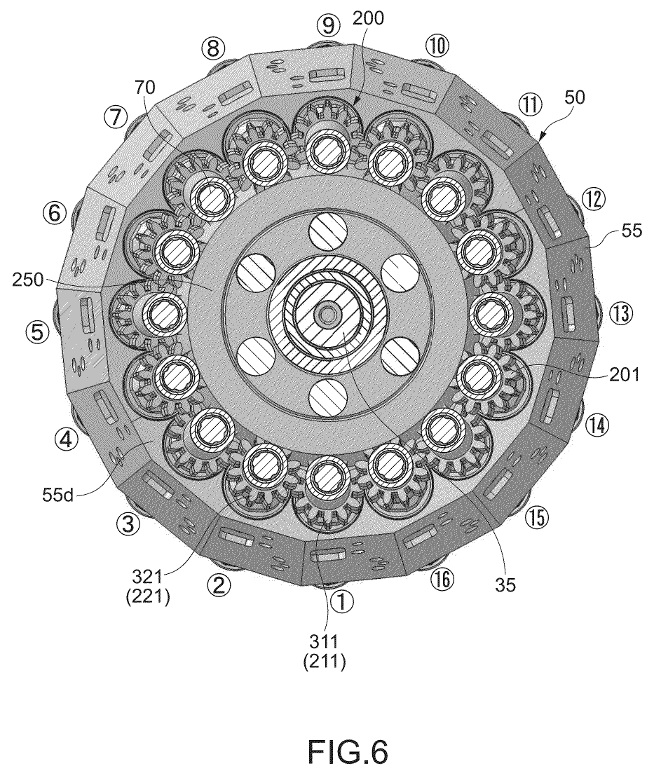

The mounting head unit 150 according to this embodiment includes a driving mechanism for making each of the plurality of nozzle units 70 rotatable. The driving mechanism will be described in detail. FIGS. 6 to 10 are schematic views for explaining a configuration of the driving mechanism in detail.

A driving mechanism 200 includes gears 201 serving as rotation mechanism sections respectively mounted on the nozzle units 70 for rotating each of the plurality of nozzle units 70. The plurality of gears 201 individually rotate with the longitudinal directions L of the nozzle units 70, to which the plurality of gears 201 are provided, being axes. Therefore, by a rotation of each gear 201, the nozzle unit 70 rotates with the longitudinal direction L being an axis. The plurality of gears 201 have almost the same shape and includes the same number of teeth.

As shown in FIG. 4 and the like, the plurality of gears 201 are mounted at different mounting positions in the longitudinal directions L of the nozzle units 70 adjacent to each other. In this embodiment, the plurality of gears 201 are alternately mounted on the plurality of nozzle units, offsetting each other at a first mounting position 311 and a second mounting position 321 different from the first mounting position 311 in the longitudinal directions L in a zigzag manner. That is, the plurality of gears 201 are mounted on the plurality of nozzle units 70 arranged with the base shaft being a center in a zigzag manner.

For convenience of description, as shown in FIG. 6, the plurality of nozzle units 70 are numbered in order. The gears 201 are mounted at the first mounting positions 311 of the nozzle units 70 each having an odd number. As shown in FIG. 5, the first mounting position 311 is a position close to the upper surface 55d of the main body 55 of the turret 50 in the longitudinal direction L of the nozzle unit 70. Hereinafter, the gear 201 mounted at the first mounting position 311 is also referred to as a first gear 211.

The gears 201 are mounted at the second mounting positions 321 of the nozzle unit 70 each having an even number. As shown in FIG. 5, the second mounting position 321 is a position away from the upper surface 55d of the main body 55 of the turret 50 by an amount corresponding to the first gear 211 in the longitudinal direction L of the nozzle unit 70. The second mounting position 321 is a position such that the mounted gear 201 and the neighbor first gear 211 do not interfere with each other. The gear 201 mounted at the second mounting position 321 is also referred to as a second gear 221.

The plurality of gears 201 are mounted in a zigzag manner as described above, and hence arrangement density of the nozzle units 70 can be increased. As a result, the number of nozzle units 70 can be increased without increasing the size of the turret 50. That is, downsizing of the mounting head unit 150 can be achieved while increasing the number of nozzle units 70 for retaining electronic components.

Further, in this embodiment, the gear 201 mounted on each of the nozzle units 70 has a configuration of a so-called scissors gear. That is, the gear 201 includes a first wheel 201a, a second wheel 201b adjacent to the first wheel 201a in the longitudinal direction L, and a biasing member (not shown). A coil spring or the like is used as the biasing member.

The first wheel 201a and the second wheel 201b have almost the same shape. Therefore, the first wheel 201a and the second wheel 201b have the same number of teeth. The second wheel 201b is provided to be movable (rotatable) with respect to the first wheel 201a. The second wheel 201b is elastically biased by the biasing member to one side in a circumferential direction with respect to the first wheel 201a. Therefore, the first wheel 201a and the second wheel 201b sandwich the gear teeth engaged to the first wheel 201a and the second wheel 201b.

The configuration and the like as the scissors gear are not limited. For example, the first wheel 201a may be fixed to the nozzle unit 70 and the second wheel 201b may be movable with respect to the nozzle unit 70. Alternatively, the first wheel 201a and the second wheel 201b may be mounted to be both movable with respect to the nozzle unit 70. Further, the biasing direction of the biasing member is typically a direction opposite to a rotation direction of the nozzle unit 70. However, those are not limited and may appropriately be set.

The driving mechanism 200 includes a rotation driving section that rotates the plurality of gears 201 mounted on the plurality of nozzle units 70. In this embodiment, a driving gear 250 engaged to the plurality of gears 201 operates as the rotation driving section.

As shown in FIG. 4, an outer tube 40 is connected to the outer peripheral surface of the base shaft 35 between the position of the base shaft 35 supported by the support 30 and the position of the base shaft 35 to which the turret 50 is connected. The outer tube 40 is connected to the base shaft 35 via bearings 43 and 44 and rotatable with respect to the base shaft 35.

To the outer tube 40, for example, a rotation driving unit using a pulley and a belt (not shown) is connected. A collar 46 retaining the bearings 43 and 44 is provided, for example, between the base shaft 35 and the outer tube 40.

In a flange 40a formed at an end portion of the outer tube 40 on a side of the turret 50, the outer tube 40 and the driving gear 250 are fixed with bolts 41. With this, the outer tube 40 and the large-diameter gear 42 rotate integrally.

As described above, in this embodiment, the driving gear 250 is provided in an area surrounded by the plurality of nozzle units 70 to be rotatable coaxially with the base shaft 35. The driving gear 250 is arranged coaxially with the base shaft 35 serving as the axis of rotation of the turret 50, and hence it is possible to easily achieve a configuration in which the turret 50 and the driving gear 250 can be rotated together, for example, using a single driving source such as a motor. As a result, downsizing of the mounting head unit 150 can be achieved.

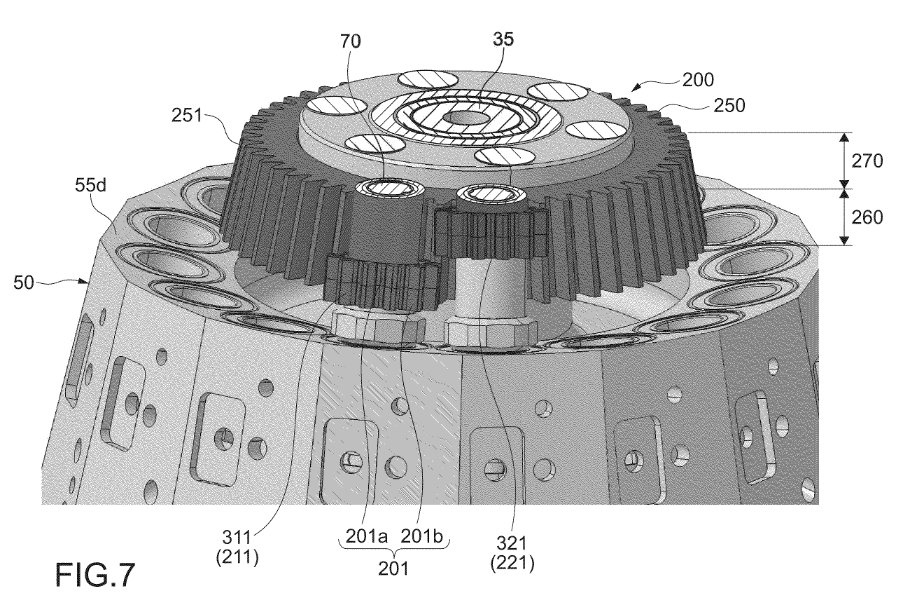

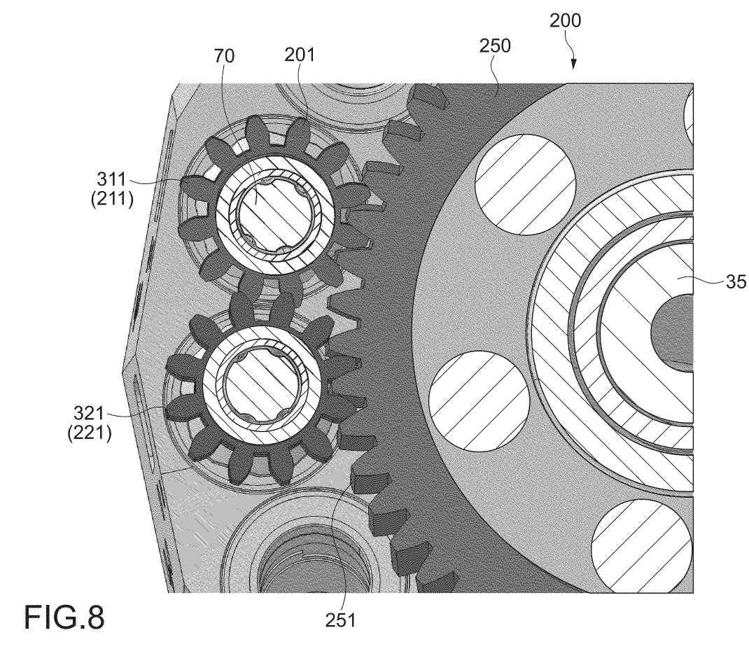

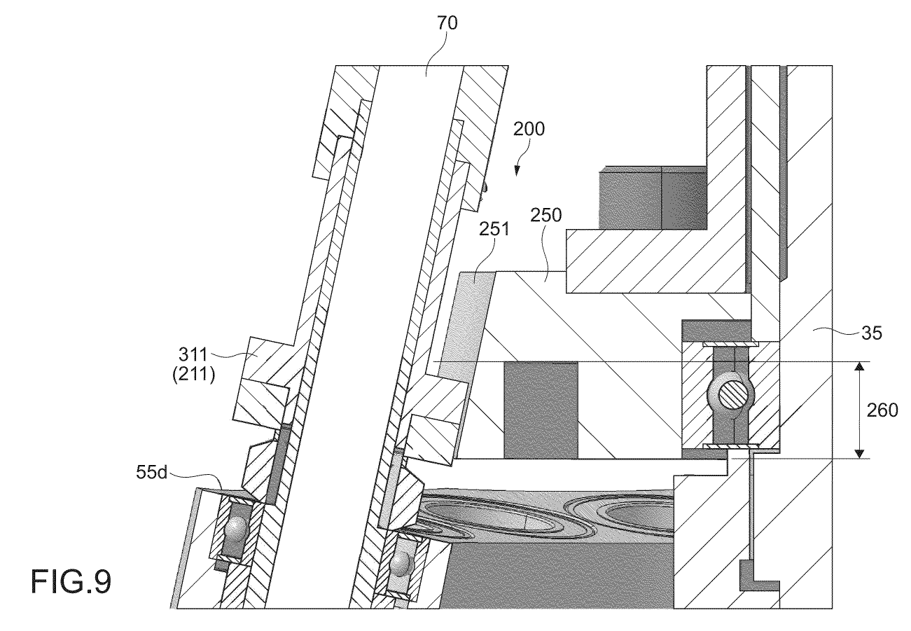

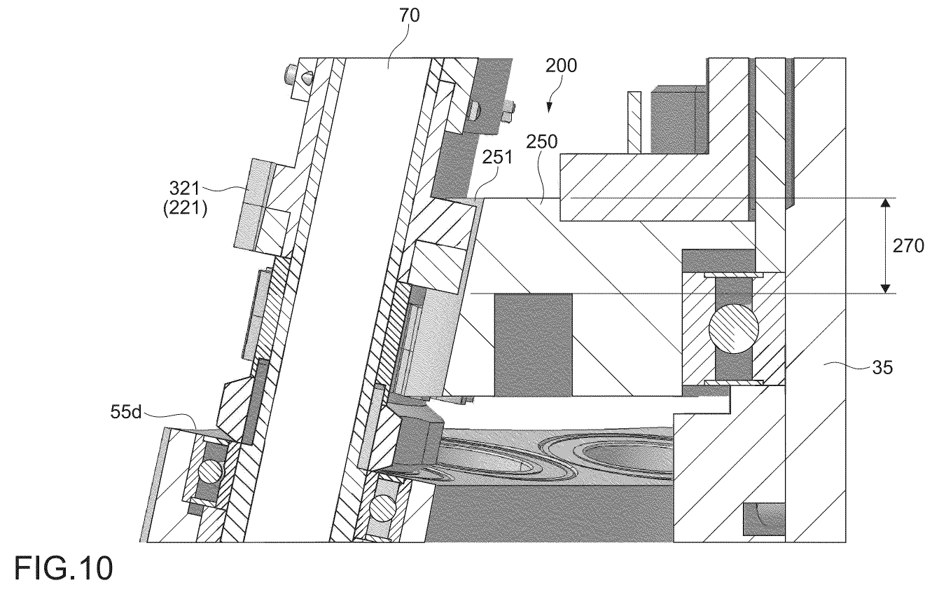

FIG. 7 is a schematic perspective view for explaining a position relationship between the driving gear 250 and the first gears 211 and the second gears 221. FIG. 8 is a plan view thereof and FIGS. 9 and 10 are cross-sectional views.

As shown in FIG. 7, the driving gear 250 includes a tapered engagement surface 251 for engaging to the plurality of gears 201. As described above, the plurality of gears 201 rotate with the longitudinal directions L of the nozzle units 70, to which the plurality of gears 201 are mounted, being axes. Therefore, the tapered engagement surface 251 of the driving gear 250 is provided in directions along the longitudinal directions L to be oblique to the base shaft 35.

As shown in FIGS. 7 and 9, a first engagement area 260 of the tapered engagement surface 251 of the driving gear 250 is engaged to the first gear 211 mounted at a first mounting position 321 of the nozzle unit 70. The first engagement area 260 is an area on a lower side of the tapered engagement surface 251. The first engagement area 260 is an area close to the upper surface 55d of the turret 50. The first engagement area 260 around the tapered engagement surface 251 is engaged to the plurality of first gears 211 respectively mounted on the plurality of nozzle units 70.

As shown in FIGS. 7 and 10, a second engagement area 270 of the tapered engagement surface 251 of the driving gear 250 is engaged to the second gear 221 located at the second mounting position 321 of the nozzle unit 70. The second engagement area 270 is an area on an upper side of the tapered engagement surface 251. The second engagement area 270 is an area away from the upper surface 55d of the turret 50. The second engagement area 270 around the tapered engagement surface 251 is engaged to the plurality of second gears 221 respectively mounted on the plurality of nozzle units 70.

As described above, the first gears 211 and the second gears 221 mounted on the plurality of nozzle units 70 in a zigzag manner are engaged to the first engagement area 260 and the second engagement area 270 of the driving gear 250. Therefore, as shown in FIG. 8, the nozzle units 70 can be arranged sufficiently close to each other such that a range of rotation of the first gear 211 and a range of rotation of the second gear 221 overlap with each other. As a result, the number of nozzle units 70 can be increased without increasing the size of the turret 50. With this, downsizing of the mounting head unit 150 can be achieved.

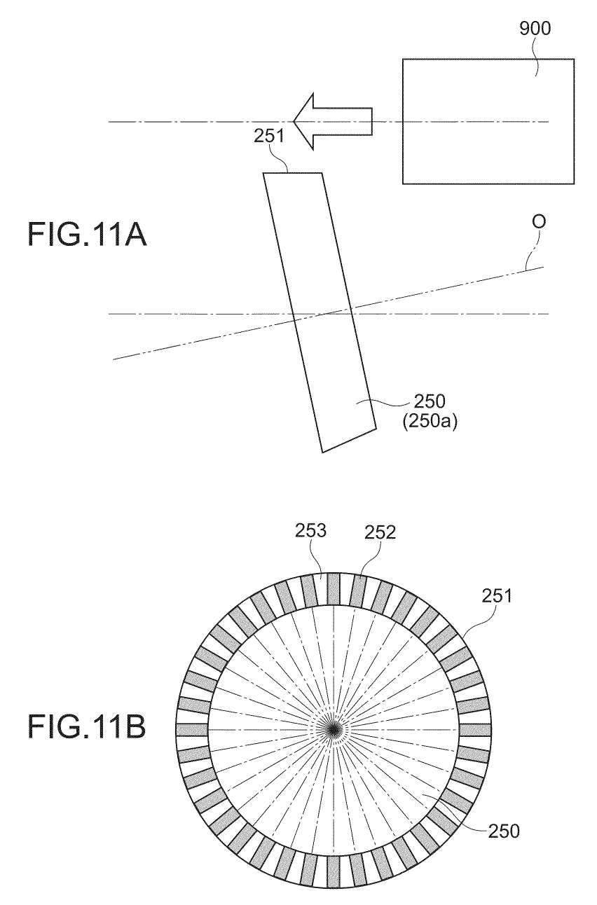

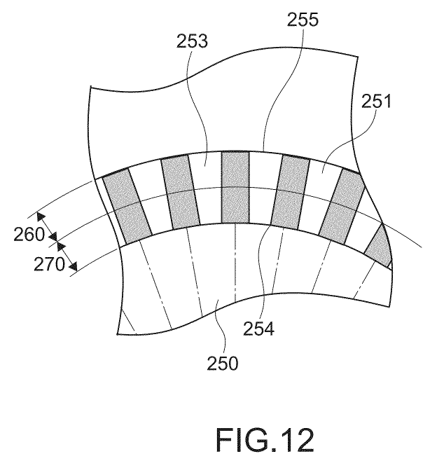

FIGS. 11A, 11B, and 12 are schematic views for explaining teeth formed in the tapered engagement surface 251 of the driving gear 250.

For example, as shown in FIG. 11A, a center axis O (axis of rotation) of a member 250a to become the driving gear 250 is tilted such that the tapered engagement surface 251 is parallel to a horizontal direction indicated by an alternate long and short dash line. The center axis O of the member 250a is shown by an alternate long and two short dashes line.

Gear cutting is performed by a blade 900 entering the tapered engagement surface 251 provided in the horizontal direction, in the same horizontal direction. Here, it is assumed that the blade 900 for forming a general spur wheel is used. The gear cutting is sequentially performed while rotating the center axis O of the member 250a. In this manner, the driving gear 250 with the teeth formed in the tapered engagement surface 251 is manufactured.

FIG. 11B is a schematic plan view of the driving gear 250 subjected to the gear cutting by the method shown in FIG. 11A. Colored portions of the tapered engagement surface 251 shown in FIG. 11B are cutting portions 252 cut by the blade 900. Portions between the cutting portions 252 are teeth 253. The alternate long and short dash lines of FIG. 11B show entering directions of the blade 900 that enters in the horizontal direction. The gear cutting may be performed in a single step by a plurality of blades capable of performing cutting along surface directions of the tapered engagement surface 251 in the entering directions and a plurality of teeth 253 may be formed.

FIG. 12 is an enlarged view showing the tapered engagement surface 251 of the driving gear 250 shown in FIG. 11B in an enlarged state. As shown in FIG. 12, in this driving gear 250, a tooth width of the teeth 253 formed is increased from an upper surface 254 to a lower surface 255 of the driving gear 250. That is, the tooth width of the teeth 253 in the first engagement area 260 engaged to the first gear 211 and the second engagement area 270 engaged to the second gear 221 is different. As a result, in some cases, adjustment and the like may be necessary for engaging each of the first gears 211 and the second gears 221 to the driving gear 250.

For example, the teeth adjacent to each other may interfere with each other on an upper surface 254 side of the second engagement area 270. Further, the tooth width may be too large on a lower surface 255 side of the first engagement area 260, which can influence engagement with the first gears 211.

In view of this, another embodiment for forming the teeth of the driving gear 250 will also be described. Note that the driving gear 250 according to this embodiment may appropriately be manufactured by the above-mentioned gear cutting step.

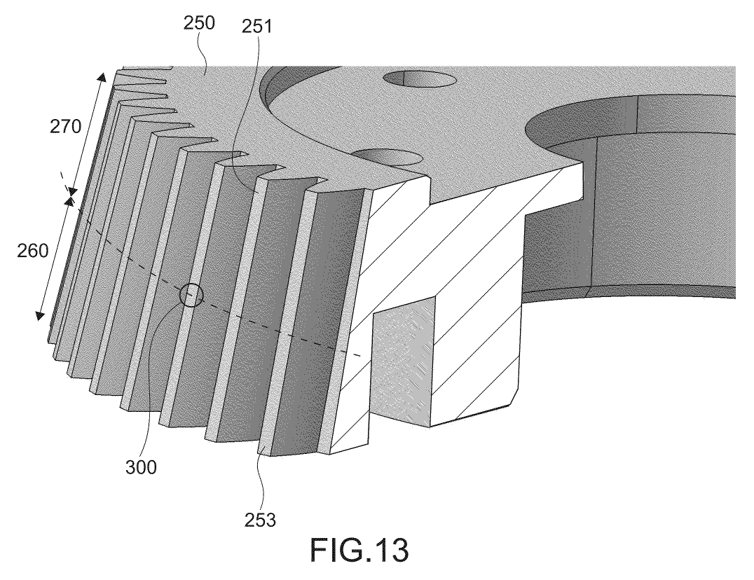

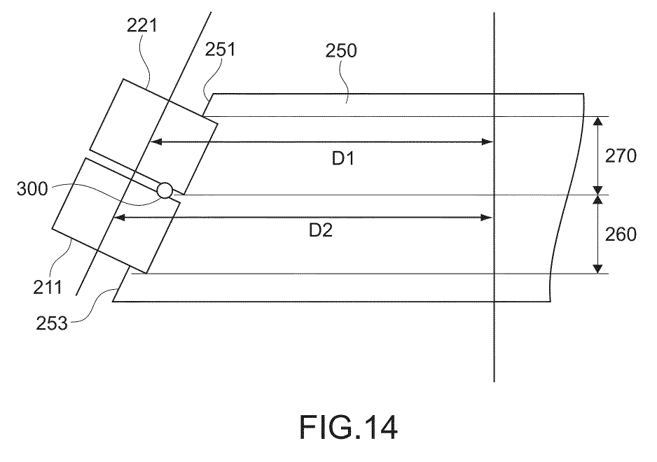

FIG. 13 is a perspective view schematically showing the driving gear 250 manufactured according to another embodiment. FIG. 14 is a view for explaining a method of manufacturing the driving gear 250 according to this embodiment.

In this embodiment, teeth are formed in the tapered engagement surface 251 with a middle point 300 between the first engagement area 260 engaged to the first gear 211 mounted at the first mounting position 311 and the second engagement area 270 engaged to the second gear 221 mounted at the second mounting position 321 being a reference of the tooth width.

“With the middle point 300 being a reference of the tooth width” means performing the gear cutting step such that the tooth width of the teeth 253 formed in the first engagement area 260 is almost equal to the tooth width of the teeth formed in the second engagement area 270 at the middle point 300.

As described above, the teeth 253 are formed in the tapered engagement surface 251 with the middle point 300 between the first engagement area 260 and the second engagement area 270 being a reference of the tooth width. With this, it is possible to sufficiently suppress variations of engagement between the driving gear 250 and the first gears 211 and the second gears 221 mounted alternately at the first mounting position 311 and the second mounting position 321. The engagement state between those gears can be made good.

Further, as shown in FIG. 14, a center distance D2 between the first gear 211 and the driving gear 250 is different from a center distance D1 between the second gear 221 and the driving gear 250. That is, the first engagement area 260 and the second engagement area 270 have different pitch circle diameters (PCD) of the driving gear 250. The center distance (or pitch circle diameter) is different, and hence it may be necessary to adjust the number, the shape, and the like of teeth of the first gears 211 and the second gears 221.

However, the teeth 253 are formed in the tapered engagement surface 251 with the tooth width at the middle point 300 being a reference, which can suppress an influence and the like due to the difference in center distance. The first gears 211 and the second gears 221 are arranged at positions closer to the middle point 300, which can sufficiently suppress the influences and the like. As a result, gears having the same number of teeth and almost the same shape may be used as the first gears 211 and the second gears 221. That is, the first gears 211 and the second gears 221 can have a constant gear ratio to the driving gear 250. As a result, corresponding to a rotation of the driving gear 250, the first gears 211 and the second gears 221 each rotate by the same angle. Therefore, it becomes easy to control rotation operations of the first gears 211 and the second gears 221. That is useful for correcting the orientations of the electronic components, which will be described later.

In this embodiment, the middle point 300 is set to be almost in the middle of the tapered engagement surface 251. With this, the teeth 253 with the tooth width at the middle point 300 being a reference can be easily formed. Further, it becomes easy to suppress variations of engagement of the first gears 211 and the second gears 221 with the driving gear 250. However, the position of the middle point 300 is not limited. For example, the first engagement area 260 and the second engagement area 270 may be arranged such that the middle point 300 is positioned at an arbitrary position of the tapered engagement surface 251.

The tooth width at the middle point 300 to become a reference may appropriately be set. The diameter and gear ratio of the driving gear 250 and the angle of the tapered engagement surface 251 may be set based on various conditions regarding the diameters and the like of the first gears 211 and the second gears 221.

### Operations of Mounting Head Unit (Method of Manufacturing Substrate)

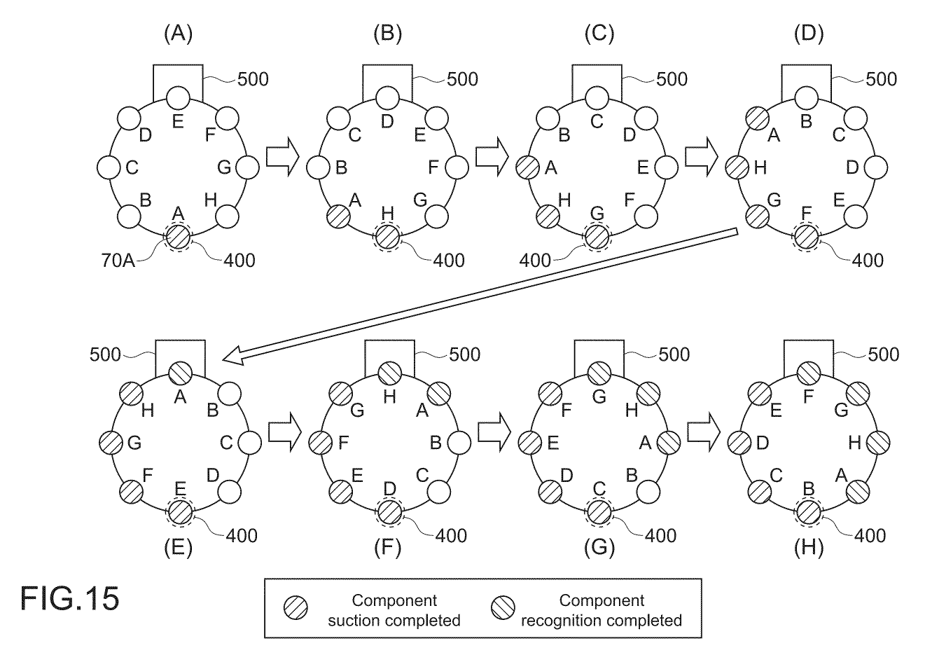

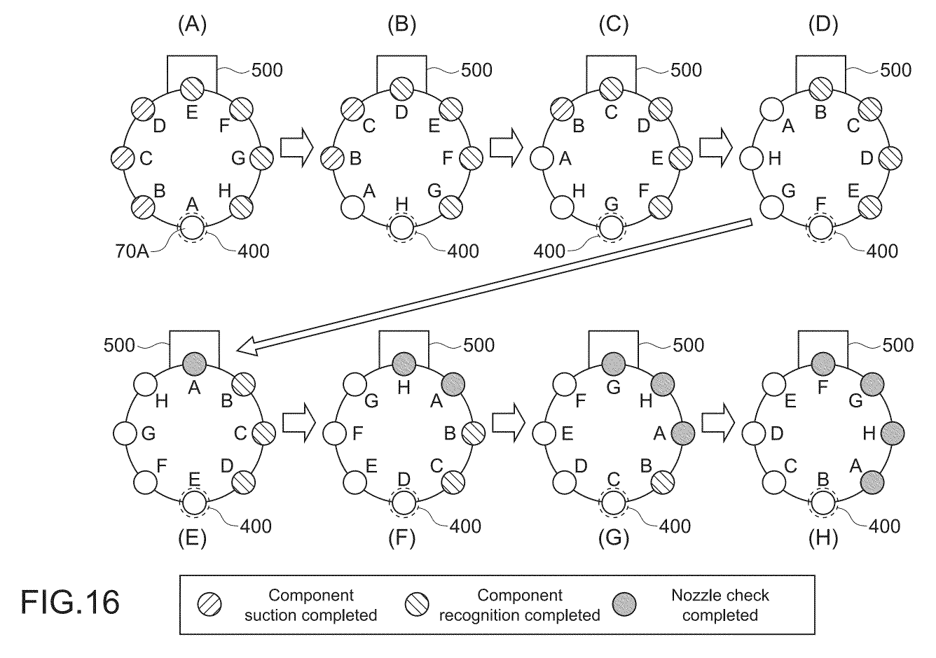

Operations of the mounting head unit according to this embodiment will be described. FIGS. 15 and 16 are schematic views for explaining suction and mounting operations of electronic components by the mounting head unit. By the operations as shown in FIGS. 15 and 16, the electronic components are mounted on the substrate W supplied to the component mounting apparatus 100 and the substrate W is manufactured.

In FIGS. 15 and 16, with a nozzle unit 70A located at a nozzle operation position 400 being a reference, nozzle units are denoted by symbols 70B to 70H in a clockwise direction.

FIG. 15 is a view for explaining the suction operations of the electronic components by the mounting head unit 150. First, in the mounting area M of the conveyor unit 16, the substrate W is positioned and retained. The mounting head unit 150 moves in a horizontal plane by the X-axis movement mechanism and the Y-axis movement mechanism to the supply area S of the electronic components.

When the mounting head unit 150 arrives at the supply area S, as shown in (A) of FIG. 15, the electronic component is sucked by the nozzle unit 70A located at the nozzle operation position 400. The pressing roller of the nozzle driving unit pushes down the nozzle 71 of the nozzle unit 70A. The nozzle unit 70A is appropriately supplied with negative-pressure air. Due to the negative pressure force, the nozzle 71 sucks the electronic component.

Next, the mounting head unit 150 rotates the turret 50 by a predetermined angle with the base shaft 35 being a center and moves the subsequent (neighbor) nozzle unit 70H to the nozzle operation position 400 ((B) of FIG. 15). The nozzle unit 70H located at the nozzle operation position 400 sucks the subsequent electronic component.

Subsequently, the rotation of the turret 50 and the suction of the electronic component by the nozzle units 70G and 70F located at the nozzle operation position 400 are similarly performed ((C) and (D) of FIG. 15).

As shown in (E) of FIG. 15, when the turret 50 rotates by almost 180 degrees, the first nozzle unit 70A that sucks the electronic component is located at an imaging position 500. The nozzle unit 70A located at the imaging position 500 is imaged by the first camera 52 and the second camera 53 and the suction state of the electronic component is recognized.

In this embodiment, as shown in FIGS. 6 and 7 and the like, the plurality of first gears 211 and the plurality of second gears 221 mounted on the plurality of nozzle units 70 are each engaged to the driving gear 250. Therefore, when the turret 50 rotates and the nozzle units 70 are moved (hereinafter, also referred to as revolution of nozzle units), each of the nozzle units 70 rotates corresponding to an angle of revolution.

Therefore, the imaging and the recognition of the suction state at the imaging position 500 are performed considering how much the electronic component being a recognition target is rotated by the revolution of the nozzle units 70. In particular, when the orientation of the sucked electronic component is recognized, it is important to grasp an angle of rotation of the nozzle unit 70. Information on the angle of rotation is appropriately used to calculate information for correcting the orientation of the electronic component. The orientation of the electronic component mounted is corrected based on the calculated correction information, and hence highly accurate mounting processing is achieved.

Information on the angle of rotation due to the revolution of the nozzle unit 70 is calculated based on, for example, information on an angle of rotation of the base shaft 35 for rotating the turret 50, an angle of rotation of the driving gear 250 for rotating the other nozzle units 70 that perform mounting at the nozzle operation position 400, and the like.

For example, the angle of rotation of the nozzle unit 70 corresponding to the angle of rotation of the base shaft 35 may be defined in advance. For example, if the driving gear 250 is designed not to rotate when the turret 50 rotates, the angle of rotation corresponding to the angle of revolution is easily calculated based on the gear ratio. Even if the driving gear 250 is designed to rotate in an opposite direction due to the rotation of the base shaft 35, the angle of rotation due to the revolution can be calculated as long as a relative angle of rotation is constant.

As shown in FIG. 5 and the like, the first gears 211 and the second gears 221 have a configuration of the scissors gear. With this, calculation of the angle of rotation and the like can be performed with high accuracy.

In the state shown in (E) of FIG. 15, there is not yet the nozzle unit 70 rotated for mounting the electronic component, information on the angle of rotation (e.g., 90 degrees) corresponding to the angle of revolution of 180 degrees only needs to be appropriately calculated and used.

Note that, in the state shown in (E) of FIG. 15, the suction operation by the nozzle unit 70E located at the nozzle operation position 400 and the imaging operation of the nozzle unit 70A located at the imaging position 500 are both performed. Therefore, the component recognition operation is performed while the component suction operation is performed, and hence it is unnecessary to additionally set a time for the component recognition. As a result, it becomes possible to perform the component mounting by the component mounting apparatus 100 for a short time.

As shown in (F) to (H) of FIG. 15, the suction operations of the electronic component at the nozzle operation position 400 and the imaging operations of the nozzle unit 70 at the imaging position 500 are sequentially performed. In the state shown in (H) of FIG. 15, the nozzle units 70B to 70E are not yet subjected to the component recognition.

FIG. 16 is a view for explaining mounting operations of the electronic components by the mounting head unit 150. When the suction operations of the electronic component are completed, the mounting head unit 150 moves above the mounting area M by the X-axis movement mechanism and the Y-axis movement mechanism.

As shown in (A) of FIG. 16, the nozzle 71 of the nozzle unit 70A located at the nozzle operation position 400 is pressed and lowered by the press roller of the nozzle driving unit. The electronic component sucked by the nozzle 71 is placed at a predetermined mounting position on the substrate W. At this time, the imaging operation of the nozzle unit 70E is performed at the imaging position 500.

Next, the mounting head unit 150 is moved by the X-axis movement mechanism and the Y-axis movement mechanism to a position at which the electronic component retained by the neighbor nozzle unit 70H is to be mounted. During or after the movement, the turret 50 is rotated and another nozzle unit 70H is located at the nozzle operation position 400. The nozzle unit 70H located at the nozzle operation position 400 mounts the electronic component ((B) of FIG. 16). At the same time, the imaging operation of the nozzle unit 70D is performed at the imaging position 500.

After that, as shown in (C) and (D) of FIG. 16, the mounting operations of the electronic component at the nozzle operation position 400 and the imaging operations of the nozzle unit 70 at the imaging position 500 are sequentially performed.

As shown in (E) of FIG. 16, when the turret 50 is rotated by almost 180 degrees, the nozzle unit 70A on which the electronic component is mounted is first located at the imaging position 500. The nozzle unit 70A is imaged by the first camera 52 and the second camera 53 and the state of the nozzle 71 is checked. With this, a determination is made as to whether or not mounting processing is correctly performed. For example, if the electronic component remains sucked by the nozzle 71, it is determined that the mounting processing has not been correctly performed. Additionally, deficiencies and the like such as deformation of the nozzle 71 may be detected.

Note that, in the state shown in (E) of FIG. 16, the mounting operation by the nozzle unit 70E located at the nozzle operation position 400 and the imaging operation of the nozzle unit 70A located at the imaging position 500 are both performed. After that, as shown in (F) to (H) of FIG. 16, the mounting operations of the electronic component at the nozzle operation position 400 and the imaging operations of the nozzle unit 70 at the imaging position 500 are sequentially performed. In the state shown in (H) of FIG. 16, the nozzle state of the nozzle units 70B to 70E has not yet been checked.

When the mounting operations of the electronic component are completed, the mounting head unit 150 is moved above the supply area S by the X-axis movement mechanism and the Y-axis movement mechanism. Then, the suction operations in FIG. 15 are performed again. In (A) to (D) of FIG. 15, the nozzle state of the nozzle units 70B to 70E only needs to be checked.

When a predetermined number of electronic components are mounted on the substrate W in the above-mentioned manner, the substrate W is unloaded by the conveyor unit 16 outside the component mounting apparatus 100. In this embodiment, the suction and mounting operations of the electronic components can be performed in a series of movements while the mounting head unit 150 is moved between the supply area S and the mounting area M. For example, it is unnecessary to move and stop the mounting head unit 150 to the imaging area for the component recognition. As a result, the component mounting processing can be performed for a short time.

As described above, in the mounting head unit 150 according to this embodiment, in order to rotate each of the plurality of nozzle units 70, the gear 201 is mounted on each of the nozzle units 70. The gears 201 are mounted at different mounting positions in the longitudinal directions L of the nozzle units 70 adjacent to each other. Therefore, the plurality of nozzle units 70 can be provided to the turret 50 such that the nozzle units 70 adjacent to each other are sufficiently close to each other in a direction across the longitudinal directions L. As a result, the number of nozzle units 70 can be increased without increasing the size of the turret 50. That is, downsizing of the mounting head unit 150 can be achieved while increasing the number of nozzle units 70 for retaining an electronic component and the like.

In this embodiment, the plurality of gears 201 are provided alternately at the first mounting position 311 and the second mounting position 321. Therefore, the gears 201 are mounted on the nozzle units 70 at the two different mounting positions, and hence the work of mounting the plurality of gears 201 to the plurality of nozzle units 70 becomes easy. That is, the mounting work is easier in comparison with a case where the plurality of gears 201 are mounted on the plurality of nozzle units 70 at many different mounting positions. Further, the configuration of the driving mechanism 200 can be prevented from being complicated. Note that the mounting positions may be set to be many different positions.

### Modified Examples

The embodiments according to the present disclosure are not limited to the above-mentioned embodiments and can be variously modified.

In each of the above-mentioned embodiments, the outer peripheral surface of the turret is tapered and the nozzle units are supported obliquely to the axis of rotation of the turret. However, the axis of rotation of the turret and the nozzle units may be set to be parallel to each other. The axis of rotation and the longitudinal directions of the plurality of nozzle units may be all set to be along the vertical direction. In this case, the driving gear having a direction of an engagement surface along the vertical direction may be provided in the area surrounded by the plurality of nozzle units.

In the above, the plurality of nozzle units are arranged in the outer peripheral portion of the turret and the turret is rotated. Thus, the suction and mounting operations of the electronic components by the plurality of nozzle units are performed. That is, in this embodiment, a rotary head is used as the mounting head unit. However, a linear head may be used as the mounting head unit. For example, the plurality of nozzle units are supported by the movable main body section along the X-axis direction. The pulley and the like serving as the rotation mechanism sections are mounted on each of the plurality of nozzle units. The pulley and the like are mounted on the nozzle units such that the pulley and the like are mounted at different mounting positions in the longitudinal directions of the nozzle units adjacent to each other. Such pulleys are each rotated by the rotation driving section including a belt and the like. With this, the plurality of nozzle units become individually rotatable. Also with such a configuration, the arrangement density of the plurality of nozzle units can be increased.

In each of the above-mentioned embodiments, the gears are used as the rotation mechanism sections and the gears are rotated by the driving gear to rotate the nozzle units. As another example of the rotation mechanism sections, a motor may be mounted on each of the nozzle units. The motors may be activated to rotate each of the nozzle units. When the motors are mounted at different mounting positions in the longitudinal directions of the nozzle units adjacent to each other, the arrangement density of the nozzle units can be increased. Additionally, the mechanisms capable of generating a torque in the nozzle units may appropriately be used as the rotation mechanism sections.

Although, in each of the above-mentioned embodiments, the plurality of gears are arranged on the plurality of nozzle units one by one in a zigzag manner in the longitudinal direction, that is, to be upper, lower, upper, lower, . . . , the arrangement of the plurality of gears is not limited thereto. The plurality of gears may be arranged in three height stages in the longitudinal direction, specifically, to be upper, middle, lower, upper, middle, lower, . . . or to be upper, middle, lower, middle, upper, . . . in the longitudinal direction of the nozzle units. Additionally, as long as the gears adjacent to each other are operable without interfering with each other, the mounting positions of the gears are not limited.

The structures of the turret, the nozzle units, the driving mechanism, and the like are not limited to the above-mentioned structures and design changes may appropriately be made.

Although, in each of the above-mentioned embodiments, the mounting head unit moves, upon mounting of the electronic component, in the plane (X-Y plane) that is substantially parallel to the mounting surface of the substrate, the substrate may move in that plane. Alternatively, both of the mounting head unit and the substrate may move in that plane.

For example, the upper portion and the lower portion of the base shaft may be supported by the support body. By employing such a both-end supporting structure, a mounting head unit having a simple, compact, and highly rigid structure can be achieved.

In each of the above embodiments, the driving mechanism for rotating each nozzle unit of the mounting head unit has been described. However, the above-mentioned technology may be used in a device and the like other than the mounting head unit.

For example, a plurality of members are each rotatably supported by the main body section. The plurality of members each have a longitudinal direction and are supported by the main body section to be arranged in a direction across the longitudinal directions. The plurality of members are used to rotate the belt and the like, for example, as part of a conveying mechanism for conveying a component and the like. Alternatively, the plurality of members are used for rotating components mounted on the plurality of members. Additionally, the application of the plurality of members is not limited.

The driving mechanism is used for rotating each of the plurality of members. The driving mechanism includes the rotation mechanism sections and the rotation driving section. The rotation mechanism sections are respectively mounted on the members such that the rotation mechanism sections are mounted at different mounting positions in the longitudinal directions of the members adjacent to each other. The rotation driving section is used for rotating each of the plurality of rotation mechanism sections mounted on the plurality of members. The rotation driving section is common to the plurality of members. An apparatus having such a configuration may be used as the rotation driving mechanism according to each of the above-mentioned embodiments.

In such a rotation driving mechanism, the plurality of members can be provided to the main body section such that the members adjacent to each other in a direction across the longitudinal directions are sufficiently close to each other. As a result, the number of members can be increased without increasing the size of the main body section. That is, downsizing of the rotation driving mechanism can be achieved while increasing the number of members.

Out of the features of each embodiment described above, at least two features may be combined.

It should be noted that the present disclosure may also take the following configurations.

(1) A mounting head unit, including:

a main body section;

a plurality of retaining sections configured to be capable of retaining a plurality of components, the plurality of retaining sections each having a longitudinal direction and rotatably supported by the main body section to be arranged in a direction across the longitudinal directions; and

a driving mechanism including a plurality of rotation mechanism sections respectively mounted on the plurality of retaining sections for rotating each of the plurality of retaining sections such that the rotation mechanism sections are mounted at different mounting positions in the longitudinal directions of the retaining sections adjacent to each other.

(2) The mounting head unit according to Item (1), in which

the driving mechanism includes a rotation driving section configured to rotate each of the plurality of rotation mechanism sections mounted on the plurality of retaining sections.

(3) The mounting head unit according to Item (2), in which

the plurality of rotation mechanism sections include a plurality of gears, and

the rotation driving section includes a driving gear configured to be engaged to each of the plurality of gears.

(4) The mounting head unit according to Item (3), in which

the main body section includes a rotating body having an axis of rotation,

the plurality of retaining sections are supported by an outer peripheral portion of the rotating body, and

the driving gear is provided in an area surrounded by the plurality of retaining sections to be rotatable coaxially with the axis of rotation.

(5) The mounting head unit according to Item (4), in which

the plurality of retaining sections are supported such that the longitudinal directions are oblique to the axis of rotation, and

the mounting head unit further includes a support body configured to support the axis of rotation obliquely to a vertical direction such that the longitudinal direction of at least one of the plurality of retaining sections is along the vertical direction.

(6) The mounting head unit according to Item (5), in which

the plurality of retaining sections are obliquely supported by the rotating body such that one end portions of the plurality of retaining sections are closer to the axis of rotation than the other end portions of the plurality of retaining sections, the other end portions being configured to retain the plurality of components,

the plurality of gears are configured to individually rotate with the longitudinal directions of the retaining sections, on which the plurality of gears are mounted, being axes, and

the driving gear includes a tapered engagement surface provided in directions along the longitudinal directions to be oblique to the axis of rotation for being engaged to each of the plurality of gears.

(7) The mounting head unit according to Item (6), in which

the plurality of gears are mounted alternately at a first mounting position and a second mounting position different from the first mounting position in the longitudinal directions of the plurality of retaining sections.

(8) The mounting head unit according to Item (7), in which

the driving gear includes teeth formed in the tapered engagement surface with a middle point between an first engagement area configured to be engaged to the gear mounted at the first mounting position and a second engagement area configured to be engaged to the gear mounted at the second mounting position being a reference of a tooth width.

(9) The mounting head unit according to any one of Items (1) to (8), in which

the plurality of retaining sections include a plurality of nozzles configured to be capable of sucking the plurality of components.

(10) The mounting head unit according to any one of Items (1) to (9), in which

the rotation mechanism sections include motors.

The present disclosure contains subject matter related to that disclosed in Japanese Priority Patent Application JP 2012-070862 filed in the Japan Patent Office on Mar. 27, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A mounting head unit, comprising:
a main body section;
a plurality of retaining sections configured to be capable of retaining a plurality of components, the plurality of retaining sections each having a longitudinal direction and rotatably supported by the main body section to be arranged in a direction across the longitudinal directions; and
a driving mechanism including a plurality of rotation mechanism sections respectively mounted on the plurality of retaining sections for rotating each of the plurality of retaining sections such that the rotation mechanism sections are mounted at different mounting positions in the longitudinal directions of the retaining sections adjacent to each other.

2. The mounting head unit according to claim 1, wherein
the driving mechanism includes a rotation driving section configured to rotate each of the plurality of rotation mechanism sections mounted on the plurality of retaining sections.

3. The mounting head unit according to claim 2, wherein
the plurality of rotation mechanism sections include a plurality of gears, and
the rotation driving section includes a driving gear to be engaged to each of the plurality of gears.

4. The mounting head unit according to claim 3, wherein
the main body section includes a rotating body having an axis of rotation,
the plurality of retaining sections are supported by an outer peripheral portion of the rotating body, and
the driving gear is provided in an area surrounded by the plurality of retaining sections to be rotatable coaxially with the axis of rotation.

5. The mounting head unit according to claim 4, wherein
the plurality of retaining sections are supported such that the longitudinal directions are oblique to the axis of rotation, and
the mounting head unit further includes a support body configured to support the axis of rotation obliquely to a vertical direction such that the longitudinal direction of at least one of the plurality of retaining sections is along the vertical direction.

6. The mounting head unit according to claim 5, wherein
the plurality of retaining sections are obliquely supported by the rotating body such that one end portions of the plurality of retaining sections are closer to the axis of rotation than the other end portions of the plurality of retaining sections, the other end portions being configured to retain the plurality of components,
the plurality of gears are configured to individually rotate with the longitudinal directions of the retaining sections, on which the plurality of gears are mounted, being axes, and
the driving gear includes a tapered engagement surface provided in directions along the longitudinal directions to be oblique to the axis of rotation for being engaged to each of the plurality of gears.

7. The mounting head unit according to claim 6, wherein
the plurality of gears are mounted alternately at a first mounting position and a second mounting position different from the first mounting position in the longitudinal directions of the plurality of retaining sections.

8. The mounting head unit according to claim 7, wherein
the driving gear includes teeth formed in the tapered engagement surface with a middle point between an first engagement area configured to be engaged to the gear mounted at the first mounting position and a second engagement area configured to be engaged to the gear mounted at the second mounting position being a reference of a tooth width.

9. The mounting head unit according to claim 1, wherein
the plurality of retaining sections include a plurality of nozzles configured to be capable of sucking the plurality of components.

10. The mounting head unit according to claim 1, wherein
the rotation mechanism sections include motors.

11. A component mounting apparatus, comprising:
a support unit configured to support a substrate;
a main body section configured to be movable above the substrate supported by the support unit;
a plurality of retaining sections configured to be capable of retaining a plurality of components and mounting the plurality of retained components on the substrate, the plurality of retaining sections each having a longitudinal direction and rotatably supported by the main body section to be arranged in a direction across the longitudinal directions; and
a driving mechanism including a plurality of rotation mechanism sections respectively mounted on the plurality of retaining sections for rotating each of the plurality of retaining sections such that the rotation mechanism sections are mounted at different mounting positions in the longitudinal directions of the retaining sections adjacent to each other.

12. A method of manufacturing a substrate by a component mounting apparatus including a support unit configured to support the substrate and a mounting head unit configured to mount a component on the substrate, the mounting head unit including
a main body section configured to be movable above the substrate supported by the support unit,
a plurality of retaining sections configured to be capable of retaining a plurality of components, the plurality of retaining sections each having a longitudinal direction and rotatably supported by the main body section to be arranged in a direction across the longitudinal directions, and
a driving mechanism including a plurality of rotation mechanism sections respectively mounted on the plurality of retaining sections for rotating each of the plurality of retaining sections such that the rotation mechanism sections are mounted at different mounting positions in the longitudinal directions of the retaining sections adjacent to each other, the method comprising:
retaining the plurality of components by the plurality of retaining sections;
rotating each of the plurality of retaining sections by the plurality of rotation mechanism sections respectively mounted on the plurality of retaining sections of the driving mechanism, to thereby adjust an orientation of each of the plurality of components retained by the plurality of retaining sections; and
moving the main body section above the substrate and mounting the plurality of components on the substrate by the plurality of retaining sections.

13. A rotation driving mechanism, comprising:
a main body section;
a plurality of members each having a longitudinal direction and rotatably supported by the main body section to be arranged in a direction across the longitudinal directions; and
a driving mechanism including
a plurality of rotation mechanism sections respectively mounted on the plurality of members for rotating each of the plurality of members such that the rotation mechanism sections are mounted at different mounting positions in the longitudinal directions of the members adjacent to each other, and
a rotation driving section used for rotating each of the plurality of rotation mechanism sections mounted on the plurality of members, the rotation driving section being common to the plurality of members.
